(19) United States
(12) Patent Application Publication
(10) Pub. No.: US 2005/0075939 A1
(43) Pub. Date: Apr. 7, 2005

(54) Managing micropayment transactions with value accounts

(75) Inventors: Dao-Ping Bao, North Delta (CA); C. Tante Garcia, Vancouver (CA); Brian Roberts, North Vancouver (CA); H. Alan Thompson, West Vancouver (CA); Ken Whiteside, North Vancouver (CA)

Correspondence Address: MORRISON & FOERSTER LLP, 425 MARKET STREET, SAN FRANCISCO, CA, 94105-2482, US

(73) Assignee: PAYSTONE TECHNOLOGIES CORPORATION

(21) Appl. No.: 10/678,441

(22) Filed: Oct. 1, 2003

(51) Int. Cl. G06F 17/60

(52) U.S. Cl. 705/26

(57) ABSTRACT

A method for managing micropayment transactions includes receiving a purchase request from a customer, where the purchase request includes a purchase item and a purchase price, and comparing the purchase price to a micropayment threshold to determine if the purchase request is a micropayment request. Then, if the purchase request is not a micropayment request, the method includes completing the purchase request as a credit transaction with a credit account. Alternatively, if the purchase request is a micropayment request, the method includes completing the purchase request as a micropayment transaction. In the latter case, completing the purchase request a micropayment transaction includes: maintaining a value account for the customer, adding a value increment to the value account from the credit account if the value account is insufficient for the purchase price, and completing the purchase request with the value account.

### BACKGROUND OF THE INVENTION

1. Field of Invention

The present invention relates to commerce generally and more particularly to Internet commerce involving relatively small payments for goods and services.

2. Description of Related Art

Internet commerce is growing rapidly. According to an estimate by Nielson/NetRatings, the number of active Internet users in January 2003 was 155 million, roughly double the estimate of 77 million for January 2000. During the same period the estimated average number of sessions per month roughly quadrupled from 18 in 2000 to 79 in 2003.

Much of this activity is related to the sale of goods and services. Typically, merchants sell goods and services either directly using a credit card merchant account, or through a third party such as eBay, one of the internet auction houses. In addition to conventional goods and services, the development of the Internet has led to the growth of online content as a commercial focus.

Online content (newspapers, music, video games, etc.) was initially supported by advertising, but recent declines in internet advertising revenue have caused more and more content providers to look for new sources of revenue. The first new source has been the subscription model wherein the provider permits the customer to access the online content in return for a fee. The initiative has met with limited success because customers are reluctant to commit to one source for all their online content. There is a recognized need for a content pay for use system wherein the customer can search the net for the desired content and then pay for only what is required. The relatively small payments required of pay for use has led to the term micropayments. A micropayment may be defined absolutely (e.g., as range from 25 cents to $20) or more generally a payment that is too small to be efficiently drawn from a conventional credit account (e.g., a credit card account).

Conventional approaches to commerce do not enable these micropayment transactions effectively. For example, magazine and newspaper publishers are currently limited to either offering content for free or through a monthly or annual subscription rather than on a ‘per article’ or ‘today's paper’ basis, thereby limiting options for revenue streams. As another example, vendors of computer games typically sell these games at the retail level on a CD for subsequent installation on the user's PC. Alternatively, such games could be marketed online for a small fee based on the number of plays similarly as in the marketing of an arcade game.

Historically, Internet commerce developed along lines that were directed towards the ease and speed of transactions generally. Because of delays associated with conventional bank accounts, current payment vehicles for Internet commerce are for the most part credit-card based. This credit-based development has occurred in spite of related problems involving security, charge backs and significant administrative costs. Consumers are often reluctant to offer credit card details online because of the risk of identity theft or fraud. Fraudulent or frivolous charge backs have become a reality of credit card based Internet commerce.

Additionally the use of credit cards limits the feasibility of micropayments. In the current business environment, credit card transactions in amounts less than $20.00 are not economically efficient either for the vendor or the card issuer. There are a number of reasons for this situation. From the vendor's perspective, the commission and fee structure involved in these transactions significantly erodes the profit margin to the point where, for true micropayments (e.g., transactions for less that $1.00), the vendor will pay transaction fees that are unacceptably high for the size of the transaction (e.g., 35 cents for a $1.00 transaction). From the card issuer's perspective, these same small transactions, even with the proportionately high transaction processing fees, are not profitable due to combined transaction processing costs and risk mitigation for defaults and chargebacks. Although the absolute threshold may fall over time, there is likely to remain a floor below which a micropayment is not acceptable as a credit transaction.

Additional limitations to Internet commerce include the accessibility to cash equivalents including, for example, the transferability between Internet accounts and ATM cash access. Conventional money transfer systems utilize various means to move money from point to point and usually the money ends up in a transfer agency account or, in some cases, a bank account. The recipient of the money can then go to the bank to collect the money or, if he has an ATM card linked to that account, he could realize the funds through an ATM. However not all fund recipients would have, or choose to have, a bank account nor would they necessarily have, or choose to have, an ATM card linked to a bank account. As a result, a cash recipient's ability to collect funds in a timely manner is limited in a way that is at odds with the real-time nature of the Internet.

Thus, there is a need for methods and systems that enable real-time Internet commerce with efficient access to credit accounts and cash equivalents.

### SUMMARY OF THE INVENTION

In one embodiment of the present invention, a method for managing micropayment transactions includes receiving a purchase request from a customer, where the purchase request includes a purchase item and a purchase price, and comparing the purchase price to a micropayment threshold to determine if the purchase request is a micropayment request. Then, if the purchase request is not a micropayment request, the method includes completing the purchase request as a credit transaction with a credit account. Alternatively, if the purchase request is a micropayment request, the method includes completing the purchase request as a micropayment transaction. In the latter case, completing the purchase request a micropayment transaction includes: maintaining a value account for the customer, adding a value increment to the value account from the credit account if the value account is insufficient for the purchase price, and completing the purchase request with the value account.

Optionally the method may include transferring a value from the value account to a cash-access account, and using an access card to access the cash-access account for at least one of a cash withdrawal at an ATM (Automatic Teller Machine), a POS (Point of Service) purchase, or a value transfer into the value account.

Preferably the method is carried out with real-time operations over the Internet. Confirmations of credit transactions can be made for direct credit purchases of goods and services as well as for value increments to the value account. Preferably, the value increment is not less than the micropayment threshold.

Additional embodiments relate to corresponding systems for managing micropayments and corresponding computer programs stored on computer-readable media. In this way, the present invention enables real-time Internet commerce with efficient access to credit accounts and optional cash equivalents.

### BRIEF DESCRIPTION OF THE DRAWINGS

FIG. 1 shows a method for managing micropayments according to an embodiment of the present invention.

FIG. 2 shows a method for accessing value accounts according to an embodiment of the present invention.

FIG. 3 shows a typical Internet network configuration as applied to the present invention.

FIG. 4 shows a typical general purpose computer as applied to the present invention.

### DETAILED DESCRIPTION OF EXEMPLARY EMBODIMENTS

Managing Micropayments

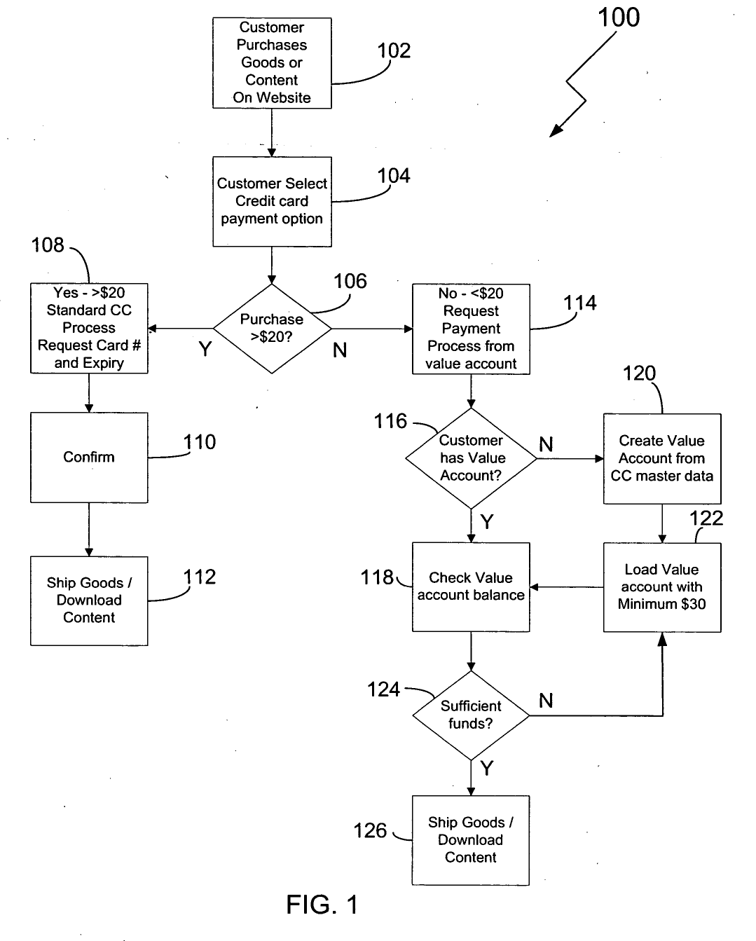

FIG. 1 shows a method 100 for managing micropayments according to an embodiment of the present invention. A customer connected to the Internet makes a purchase request on a website 102 and selects a credit card option for payment 104. Typically the purchase request includes purchase item (e.g., product number or description) and a purchase price (e.g., a dollar amount) as well although other information may also be included (e.g., a delivery specification). Specifying the credit card option 104 may include input and storage of corresponding credit information (e.g., account number and expiration date).

A comparison 106 is made between the purchase price and some micropayment threshold to determine whether or not the purchase request should be treated as a micropayment request. In the illustrated method 100, the micropayment threshold is $20 and the comparison is simply whether or not the purchase price is greater than $20. Alternative comparisons are also possible including, for example, different thresholds for different types of purchases.

In the case where the threshold is exceeded 108, the purchase request is treated as a credit transaction with a credit account, typically requiring an account number and an expiration date. This information may be acquired at this time or recalled from storage (e.g., previously acquired when the credit option is specified 104). Upon confirmation of the credit transaction 110 (e.g., in real time), the goods and services are provided to the customer 112. This may include a shipping order for goods or a download authorization for Internet content.

In the case where the threshold is not exceeded 114, the purchase request is treated as a micropayment transaction where the payment comes from a value account (e.g., a cash-based account) associated with the customer. As a preliminary matter, a determination 116 is made as to whether a value account exists for the customer. In the case where a value account does not exist, a value account is created by associating the credit account with the value account. As discussed above a corresponding account number and expiration date can be input at this time or recalled from storage (e.g., previously acquired when the credit option is specified 104). Then the value account is loaded (e.g., infused with cash) from the credit account by a value increment (e.g., $30 in the illustrated method 100).

A check of the value account balance 118 is made after loading a (newly created) value account 122 or after determining that a value account exists 116. The value account is compared 124 with the purchase price to determine if the transaction can be completed by debiting the value account. If the value account has sufficient funds, then the transaction is completed by debiting the value account by the amount of the purchase price, and the goods and services are then provided to the customer 126. If sufficient funds are not available in the value account 124, then the value account can be loaded 122 additionally by the value increment 122 in order to complete the transaction.

As illustrated by the above method 100, the present invention enables a bifurcation of transactions so that sufficiently large transactions (e.g., purchase price greater than the micropayment threshold 108) are completed directly by the credit account 110, while smaller transactions (e.g. purchase price less than or equal to the micropayment threshold) are completed by debiting a value account that is only occasionally incremented from the credit account as needed 122. Additionally, the credit account described in the above method 100 may also have component sub-accounts as for example when different credit card accounts are used for the a direct credit transaction 110 and for maintaining the value account 122.

By setting the value increment so that it is no less than the micropayment threshold, one guarantees that no more than one credit transaction is carried out either in the branch corresponding to the credit transaction 110 or as a micropayment transaction 122. Further, by setting the micropayment threshold sufficiently large (e.g., at least $20), one can assure that only efficient or cost-effective credit transactions are made (e.g., profitable for a credit card issuer).

Preferably all communications in the method 100 are carried out over the Internet in real time so as to complete transactions quickly without necessarily requiring a credit card transaction at each stage. Preferably the value account is maintained by a fund transfer agent and not a bank or similarly regulated financial entity so as to avoid corresponding delays.

Additional Access to Value Accounts

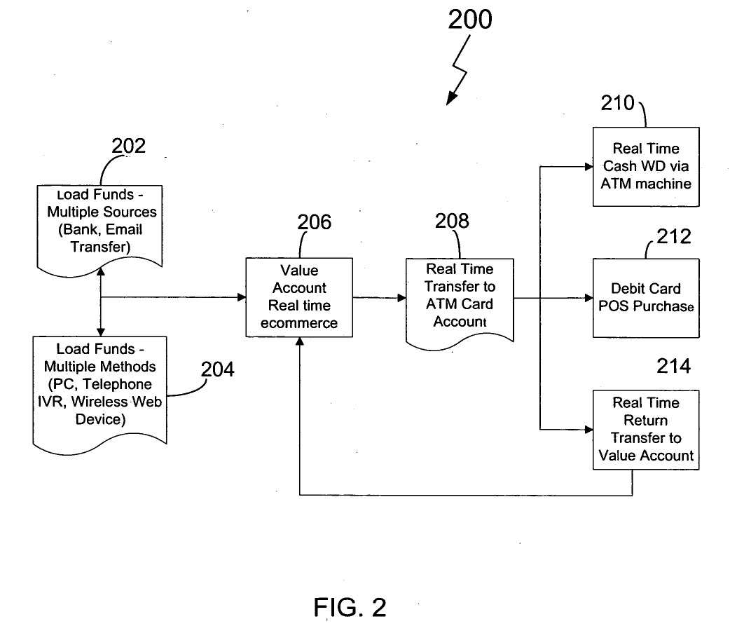

FIG. 2 shows a method for accessing value accounts according to an embodiment of the present invention. Funds can be loaded into a value account from multiple sources 202 and by a variety of methods 204. The sources 202 may include bank accounts, credit accounts and other value accounts. The methods 204 may include a PC (personal computer) over the Internet, telephonic IVR (interactive voice recognition), and wireless web devices over the Internet. The value account is then available for real-time Internet ecommerce 206 (e.g., as the method 100 shown in FIG. 1)

Notably there are constraints associated with different combinations of sources 202 and methods 204. For example, non-real-time delays are typically associated with bank accounts. Additionally, value accounts maintained by a fund transfer agent may have greater flexibility in available transfer methods (e.g., transfer by email) not available from other sources.

Because of the real-time availability of the value account 206, transfers can be made 208 to another account for direct cash access (e.g., an ATM (Automatic Teller Machine) card account). Preferably these transfers 208 are made in real time via the Internet. Then from this separate cash-access account, a variety of cash-based transfers can be made in real time including a cash withdrawal at an ATM machine 210, a debit card POS (Point Of Service) purchase 212, or a transfer back to the original value account 214 (or alternatively another value account). By monitoring and controlling the balance in a cash-access account, the user of a value account can for example enforce budgetary restraints on the user of the cash-access account.

Preferably the value-accounts and cash-access accounts are maintained by a fund transfer agent rather than a bank or similar financial institution. Analogous transactions with banks may involve additional burdens (e.g., bank transfer delays, maintenance of a traditional bank account, credit worthiness determinations).

The above method 200 desirably enables a real-time transfer between Internet-based funds and cash-based funds in a way that flexibly connects commerce across these settings.

Operating Environment

The embodiments shown in FIG. 1 and FIG. 2 are preferably carried out using standard Internet connections and general-purpose computers (e.g. PC's, servers). For example, standard Internet connections can be used to connect general purpose-computers related to customers, merchants and a value-account system that maintains value accounts as well as related cash-value accounts.

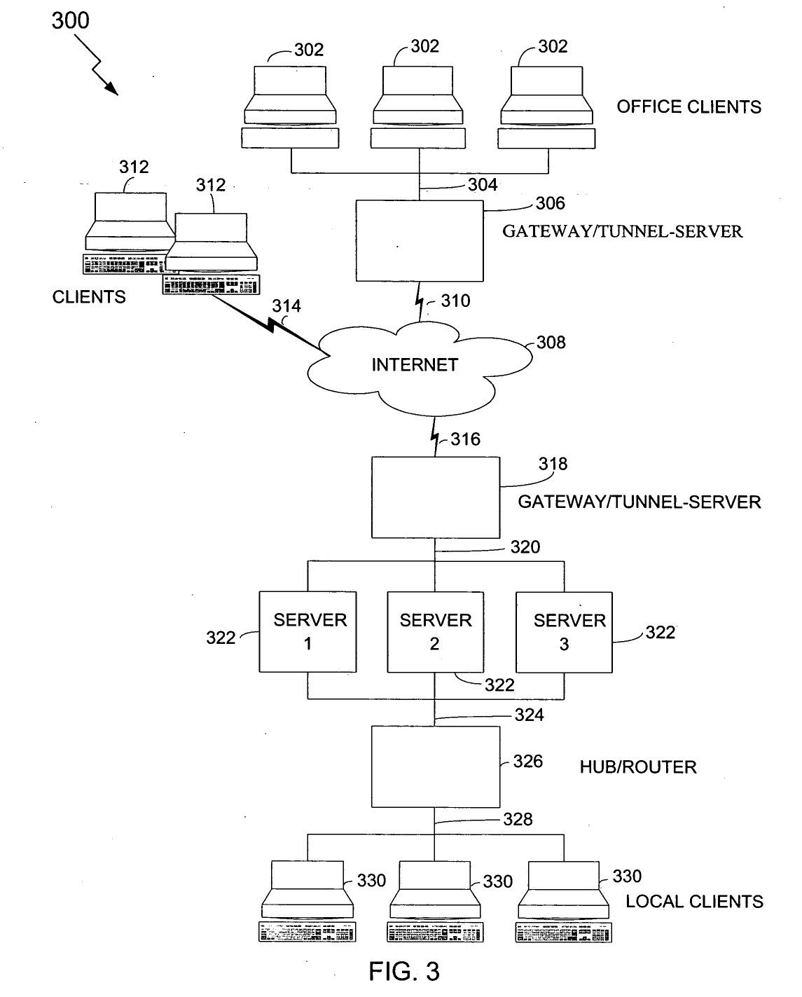

Some of the elements of a typical Internet network configuration 300 are shown in FIG. 3, where a number of office client machines 302, possibly in a branch office of an enterprise, are shown connected 304 to a gateway/tunnel-server 306 which is itself connected to the Internet 308 via some internet service provider (ISP) connection 310. Also shown are other possible clients 312 similarly connected to the internet 308 via an ISP connection 314. An additional client configuration is shown for local clients 330 (e.g., in a home office). An ISP connection 316 connects the Internet 308 to a gateway/tunnel-server 318 that is connected 320 to various enterprise application servers 322. These servers 322 are connected 324 to a hub/router 326 that is connected 328 to various local clients 330.

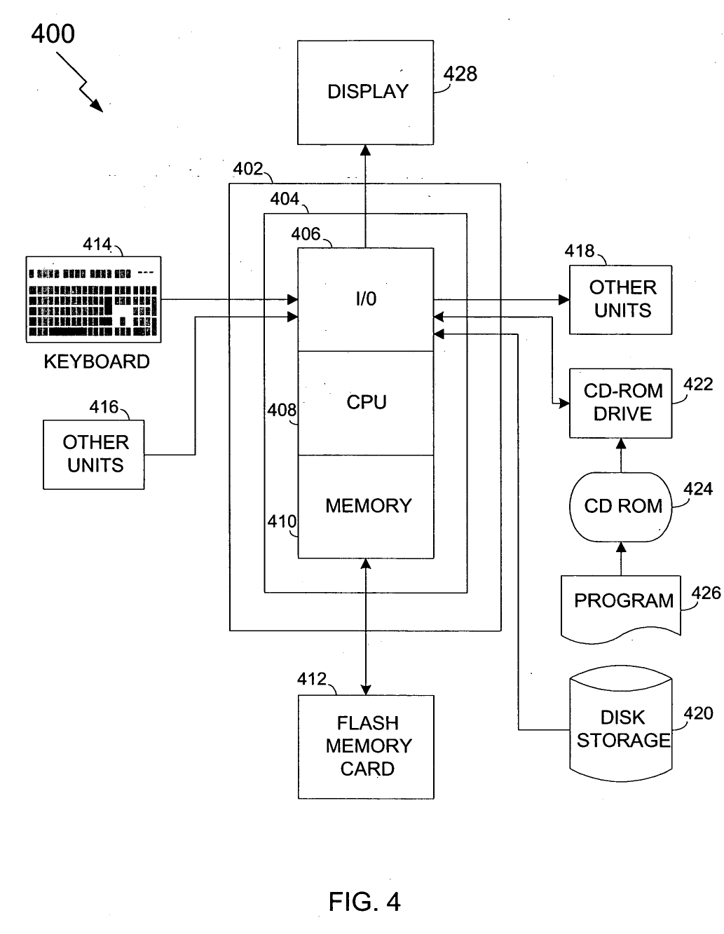

FIG. 4 shows a typical general purpose computer 400 with a number of standard components. The main system 402 includes a motherboard 404 having an input/output (“I/O”) section 406, one or more central processing units (“CPU”) 408, and a memory section 410, which may have a flash memory card 412 related to it. The I/O section 406 is connected to a display 428, a keyboard 414, other similar general-purpose computer units 416, 418, a disk storage unit 420 and a CD-ROM drive unit 422. The CD-ROM drive unit 422 can read a CD-ROM medium 434 which typically contains programs 426 and other data. Logic circuits or other components of these programmed computers will perform series of specifically identified operations associated with customers, merchants, and value-account systems.

Additional Embodiments

Although only certain exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A method for managing micropayment transactions, comprising:
receiving a purchase request from a customer, the purchase request including a purchase item and a purchase price;
comparing the purchase price to a micropayment threshold to determine if the purchase request is a micropayment request;
if the purchase request is not a micropayment request, completing the purchase request as a credit transaction with a credit account; and
if the purchase request is a micropayment request, completing the purchase request as a micropayment transaction, wherein completing the purchase request a micropayment transaction includes:
maintaining a value account for the customer,
adding a value increment to the value account from the credit account if the value account is insufficient for the purchase price, and
completing the purchase request with the value account.

2. A method according to claim 1, further comprising:
transferring a value from the value account to a cash-access account; and
using an access card to access the cash-access account for at least one of a cash withdrawal at an ATM (Automatic Teller Machine), a POS (Point of Service) purchase, or a value transfer into the value account.

3. A method according to claim 1, wherein receiving the purchase request includes receiving the purchase request as an Internet signal.

4. A method according to claim 1, wherein completing the purchase request when the purchase request is a micropayment request includes confirming a valid credit transaction for the credit account.

5. A method according to claim 1, wherein completing the purchase request when the purchase request is a micropayment request includes sending an Internet request for goods or services.

6. A method according to claim 1, wherein completing the purchase request when the purchase request is not a micropayment request includes confirming a valid credit transaction for the credit account.

7. A method according to claim 1, wherein completing the purchase request when the purchase request is not a micropayment request includes sending an Internet request for goods or services.

8. A method according to claim 1, wherein the value increment is not less than the micropayment threshold.

9. A system for managing micropayment transactions, comprising:
transaction center connected to the Internet for communication with purchasers and sellers of some combination of goods and services, the transaction center including executable instructions for:
receiving a purchase request from a customer, the purchase request including a purchase item and a purchase price;
comparing the purchase price to a micropayment threshold to determine if the purchase request is a micropayment request;
if the purchase request is not a micropayment request, completing the purchase request as a credit transaction with a credit account; and
if the purchase request is a micropayment request, completing the purchase request as a micropayment transaction, wherein completing the purchase request a micropayment transaction includes:
maintaining a value account for the customer,
adding a value increment to the value account from the credit account if the value account is insufficient for the purchase price, and
completing the purchase request with the value account.

10. A system according to claim 9, further comprising executable instructions for:
transferring a value from the value account to a cash-access account; and
using an access card to access the cash-access account for at least one of a cash withdrawal at an ATM (Automatic Teller Machine), a POS (Point of Service) purchase, or a value transfer into the value account.

11. A system according to claim 9, wherein receiving the purchase request includes receiving the purchase request as an Internet signal.

12. A system according to claim 9, wherein completing the purchase request when the purchase request is a micropayment request includes confirming a valid credit transaction for the credit account.

13. A system according to claim 9, wherein completing the purchase request when the purchase request is a micropayment request includes sending an Internet request for goods or services.

14. A system according to claim 9, wherein completing the purchase request when the purchase request is not a micropayment request includes confirming a valid credit transaction for the credit account.

15. A system according to claim 9, wherein completing the purchase request when the purchase request is not a micropayment request includes sending an Internet request for goods or services.

16. A system according to claim 9, wherein the value increment is not less than the micropayment threshold.

17. Computer-readable media tangibly embodying a computer program for managing micropayment transactions, the computer program comprising executable instructions for:
receiving a purchase request from a customer, the purchase request including a purchase item and a purchase price;
comparing the purchase price to a micropayment threshold to determine if the purchase request is a micropayment request;
if the purchase request is not a micropayment request, completing the purchase request as a credit transaction with a credit account; and
if the purchase request is a micropayment request, completing the purchase request as a micropayment transaction, wherein completing the purchase request a micropayment transaction includes:
maintaining a value account for the customer,
adding a value increment to the value account from the credit account if the value account is insufficient for the purchase price, and
completing the purchase request with the value account.

18. Computer-readable media according to claim 17, further comprising:
transferring a value from the value account to a cash-access account; and
using an access card to access the cash-access account for at least one of a cash withdrawal at an ATM (Automatic Teller Machine), a POS (Point of Service) purchase, or a value transfer into the value account.

19. Computer-readable media according to claim 17, wherein receiving the purchase request includes receiving the purchase request as an Internet signal.

20. Computer-readable media according to claim 17, wherein completing the purchase request when the purchase request is a micropayment request includes confirming a valid credit transaction for the credit account.

21. Computer-readable media according to claim 17, wherein completing the purchase request when the purchase request is a micropayment request includes sending an Internet request for goods or services.

22. Computer-readable media according to claim 17, wherein completing the purchase request when the purchase request is not a micropayment request includes confirming a valid credit transaction for the credit account.

23. Computer-readable media according to claim 17, wherein completing the purchase request when the purchase request is not a micropayment request includes sending an Internet request for goods or services.

24. Computer-readable media according to claim 17, wherein the value increment is not less than the micropayment threshold.
